(19) United States
(12) Patent Application Publication
(10) Pub. No.: US 2012/0240103 A1
(43) Pub. Date: Sep. 20, 2012

(54) METHOD AND SYSTEM FOR IMPLEMENTING SELF-CONFIGURABLE SOFTWARE COMPONENTS

(75) Inventors: Srinivas Padmanabhuni, Bangalore (IN); Sudeep Mallick, Bangalore (IN); Deepti Parachuri, Hyderabad (IN)

(73) Assignee: INFOSYS TECHNOLOGIES LIMITED, Bangalore (IN)

(21) Appl. No.: 13/073,501

(22) Filed: Mar. 28, 2011

(30) Foreign Application Priority Data
Mar. 14, 2011 (IN) 758/CHE/2011

(51) Int. Cl. G06F 9/44

(52) U.S. Cl. 717/121

(57) ABSTRACT

A system and method for implementing automatic self-configuration of a software component for servicing consumer requests is provided. The method includes receiving a consumer request for a software service by the software component. The method further includes creating one or more rules for defining one or more significant parameters of the software component based on requirements of the consumer request. Thereafter, current values of the one or more parameters are determined by a software agent implemented by the software component. Current values of the one or more parameters are then compared with values defined as per the created rules for checking whether requirements for servicing the consumer request are conformed. If it is determined that requirements for servicing the consumer request are not conformed, at least one parameter of the one or more parameters is configured. Following configuration of the parameter, the consumer request is executed.

### FIELD OF INVENTION

The present invention generally relates to software systems. More specifically, the present invention relates to a system and method that implements a software model comprising self-configuring software components that are capable of automatically coordinating with participating components in order to process consumer requests.

### BACKGROUND OF THE INVENTION

The complexities associated with software systems in use are associated with satisfying various functional requirements, such as fast performance, security and interoperability. In order to satisfy these requirements, software systems are implemented using a plurality of software components. A software component is a reusable software module which is capable of offering a pre-defined service with functionalities that can be configured in order to process service requests. Software components are system and platform independent and are designed in conformation with standardized industry specifications such as Component Object Model (COM), Common Object Request Broker Architecture (CORBA) etc. Typically, software components are capable of interacting with other components within software architecture for the purpose of processing service requests.

With increase in the complexity of Information Technology (IT) systems in recent times, requirements of individual service consumers are distinct in nature. Further, requirements of a service consumer are dynamic and may change with time. Thus, in order to process consumer requests, software components are required to be reconfigured frequently. One of the shortcomings of currently implemented software systems is that the reconfiguration is required to be performed manually. Also, since processing a particular consumer request may involve interaction among multiple components, changes in requirements of a service request may require changing the negotiating or invoking parameters corresponding to one or more components participating in processing the request.

In view of the foregoing, there is a clear need for a software model that overcomes the stated drawbacks of current systems. In addition, there is a need for a framework that facilitates reconfiguration of software components and the associated parameters without any manual intervention. Further, a reconfigured component should be automatically deployable and executable within existing runtime platforms for prompt processing of service requests.

### SUMMARY OF THE INVENTION

A system and method for implementing automatic self-configuration of a software component for servicing consumer requests is provided. The method includes receiving a consumer request for a software service by the software component. In various embodiments of the present invention, the software component includes a software agent adapted to automatically configure the software component based on requirements of the consumer request. The method further includes creating one or more rules for defining one or more parameters of the software component based on requirements of the consumer request. The one or more parameters are detected to be significant to realization of the consumer request, wherein the one or more parameters are programmed to be monitorable and configurable by the software agent. The method further includes determining current values of the one or more parameters and checking whether requirements for servicing the consumer request are conformed. If it is determined that requirements for servicing the consumer request are not conformed, at least one parameter of the one or more parameters is configured by the software agent by setting values for the at least one parameter. Finally, the consumer request is executed.

In various embodiments of the present invention, checking of requirements for servicing the consumer request is performed by the software agent by comparing current values of the one or more parameters with values defined as per the created rules.

In various embodiments of the present invention, current values of the one or more parameters are determined by dynamically monitoring their values.

In various embodiments of the present invention, the one or more parameters include parameters of participating software components, wherein the participating software components are components involved in servicing the consumer request in addition to the software component. The current values of the one or more parameters are obtained by combining individual parameter values of the participating software components with values of parameters of the software component. In an embodiment of the present invention, individual parameter values are obtained from a shared software library implemented using a blackboard application.

In various embodiments of the present invention, the software component is a coarse grained component. In an embodiment of the present invention, the software agent is composed using an Integrated Development Environment (IDE), wherein the IDE is a Java-based environment. In another embodiment of the present invention, the software agent is composed using an Integrated Development Environment (IDE), wherein the IDE is a .NET software framework.

In various embodiments of the present invention, configuration and monitoring of the one or more parameters is performed during run time processing of the consumer request.

In various embodiments of the present invention, the one or more parameters are detected based on various criteria such as type of consumer request, source of consumer request, security aspects of the consumer request etc.

In various embodiments of the present invention, executing the consumer request includes interpreting an Agent Definition Language file, wherein the Agent Definition Language file comprises software code containing instructions for configuring parameter values of the software component and for processing the consumer request.

In various embodiments of the present invention, the Agent Definition Language file further comprises software code containing instructions for deriving current values of the one or more parameters from a software file storing updated values of the one or more parameters. The current values of the one or more parameters are monitored and stored in the software file based on acceptable range of parameters.

The system for implementing automatic self-configuration of a software component for servicing consumer requests includes a software component comprising a software agent created to operate on behalf of the software component and adapted to detect one or more parameters significant to realization of the consumer request, to create rules defining configurable and monitorable parameters of the component, to obtain current values of the configurable parameters, to configure values of the parameters based on requirements of the consumer request and to execute operations for processing the consumer request. The system further includes a component properties module configured to implement software functions or procedures describing the one or more parameters.

In various embodiments of the present invention, the system includes a monitor component configured to continuously measure values of the one or more parameters and a monitor properties module configured to receive and store updated values of the one or more parameters from the monitor component. Further, the system includes a range properties module configured to store acceptable ranges of values of the one or more parameters.

In various embodiments of the present invention, the software agent includes a parser configured to examine the consumer request and determine the configurable and monitorable parameters of the software component. The software agent is further adapted to compare rules defining the configurable and monitorable parameters with current values of the parameters based on requirements of the consumer request in order to determine whether the parameters are to be configured. The configuration of parameters is realized by the software agent by setting values of parameters based on requirements of the consumer request.

In various embodiments of the present invention, operations for processing the consumer request are described in an ADL file, wherein the operations are described based on a BDI software model.

In various embodiments of the present invention, the software agent includes a BDI interpreter configured to read current values of the configurable and monitorable parameters from the monitor properties module and further configured to interpret the ADL file for configuring values of the one or more parameters. The software agent is further configured to coordinate with components participating in servicing the consumer request in order to derive current values of parameters of the participating components.

In various embodiments of the present invention, the software agent is composed using an Integrated Development Environment.

### BRIEF DESCRIPTION OF THE ACCOMPANYING DRAWINGS

The present invention is described by way of embodiments illustrated in the accompanying drawings wherein:

FIG. 1 illustrates a block diagram of a system modeling automatic self-configuration of a software component and its associated parameters, in accordance with an embodiment of the present invention.

FIGS. 2 and 3 are a flow diagram illustrating an exemplary implementation of a series of method steps for automatic configuration of a software component in order to service a consumer request, in accordance with an embodiment of the present invention.

### DETAILED DESCRIPTION OF THE INVENTION

The disclosure is provided in order to enable a person having ordinary skill in the art to practice the invention. Exemplary embodiments herein are provided only for illustrative purposes and various modifications will be readily apparent to persons skilled in the art. The general principles defined herein may be applied to other embodiments and applications without departing from the spirit and scope of the invention. The terminology and phraseology used herein is for the purpose of describing exemplary embodiments and should not be considered limiting. Thus, the present invention is to be accorded the widest scope encompassing numerous alternatives, modifications and equivalents consistent with the principles and features disclosed herein. For purpose of clarity, details relating to technical material that is known in the technical fields related to the invention have been briefly described or omitted so as not to unnecessarily obscure the present invention.

Embodiments of the present disclosure include systems and methods for modeling a collection of autonomic coarse grained components that reconfigure themselves and coordinate with participating components automatically to cater to changing consumer requirements. A software framework is provided for developing components with an ability to read consumer requirements in real time and reconfigure them accordingly. Reconfiguring involves changing component parameters, environment parameters and interacting/negotiating with participating components.

The present invention would now be discussed in context of embodiments as illustrated in the accompanying drawings.

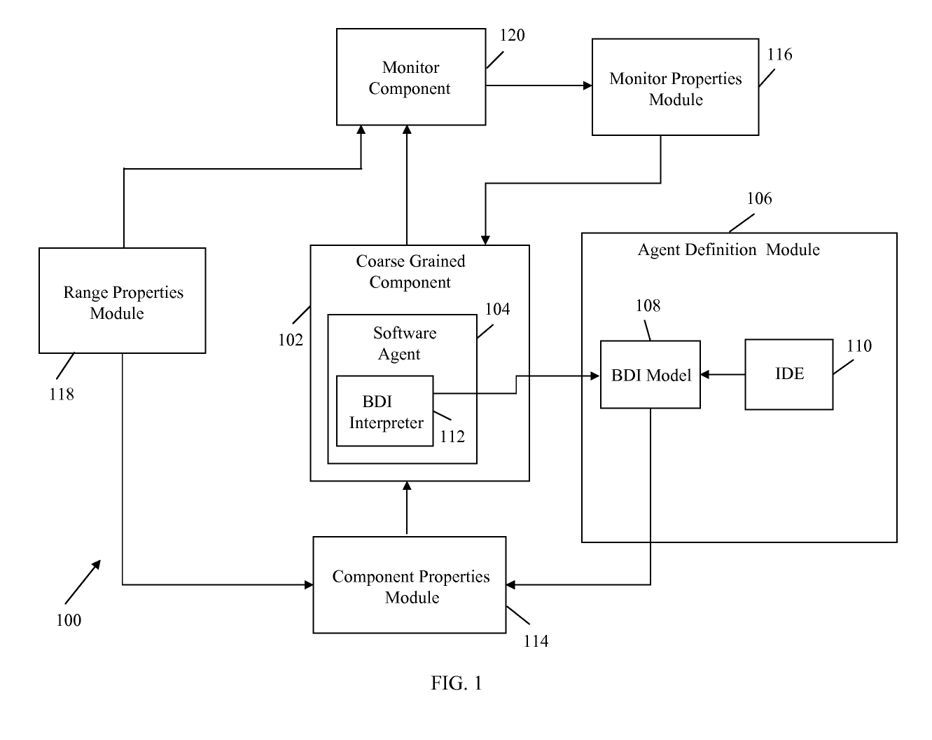

FIG. 1 illustrates a block diagram of a system 100 modeling automatic self-configuration of a software component and its associated parameters, in accordance with an embodiment of the present invention. The present invention implements an autonomic computing mechanism for employing self-configuration of a software component. An autonomic system comprises an interactive collection of autonomic elements that are capable of managing their internal behavior and their relationship with other autonomic elements in accordance with pre-defined policies. Each autonomic element is pre-configured to perform a unique functionality. In various embodiments of the present invention, the autonomic elements facilitating self-configuration include one or more software agents that co-operate with each other for implementing self-configuration of the component. A software agent is a software object which functions continuously and autonomously in a particular environment. A software agent is typically defined in terms of its behavior in a software environment, as opposed to being defined in terms of its methods and attributes. The operation of an agent is defined to be responsive to changes in a software environment without requiring constant human guidance or intervention. A typical example of changes in the software environment may include changes in requirements associated with service requests. In various embodiments of the present invention, when the one or more software agents are configured to interoperate with each other within a software environment, each agent inhabits parameters of the environment along with other agents.

As shown in the figure, system 100 includes a component 102 defined for processing a particular software service request. Component 102 may be implemented as part of a software service application implemented on an application server within a software system. The software service application may be requested by one or more client applications within the software system or by a client application within an external system connected to the software system by a computer network. Examples of a computer network may include, but are not limited to, a Local Area Network (LAN), a Wide Area Network (WAN), a Metropolitan Area Network (MAN), a Personal Area Network (PAN), and the like. In another embodiment of the present invention, the component 102 may be a service provider component deployed within a Service Oriented Architecture (SOA) and accessible by one or more client applications using web services. In various embodiments of the present invention, the component 102 may be configured to independently process a service consumer request. In other embodiments of the present invention, the component 102 may need to communicate with other software components in order to service the request. Component 102 may interact with participating components within a software environment, wherein the software environment may be a computer network linking together the software components.

In various embodiments of the present invention, component 102 is defined to be a coarse grained component. A coarse grained component represents a specialized form of a software component with loosely defined component interfaces. A critical functionality which is loosely defined for implementing a coarse grained component includes degree of coupling between the component 102 and a service consumer. Functional aspects that characterize a loosely defined coarse grained component may include specifications related to data exchange, versioning, transport independence, interaction pattern, conversations, mediation, dynamicity etc. In various embodiments of the present invention, for composing the coarse grained component 102, data exchanges may be defined to be programming language-independent and service functionality associated with the component may be specified to be transport protocol independent. Further, coarse grained component 102 may be defined to be container independent by employing minimal use of container framework resources.

Since coarse grained components are easily programmable, in various embodiments of the present invention, coarse grained component 102 is programmed to be agent-enabled in order to implement automatic self-configuration. In an embodiment of the present invention, software code for autonomic behavior is created as part of the component 102 in order to make it agent-enabled. In another embodiment of the present invention, software code for autonomic behavior is injected as part of existing code of the component 102 during deployment stages. Software agent 104 is designed to operate on behalf of the component 102 so as to automatically configure it based on requirements of service consumer requests. Automatic configuration of component 102 is realized by the software agent 104 by interpreting an Agent Definition Language (ADL) file. An ADL file is an executable file comprising software code describing operations for processing a service consumer request. In an embodiment of the present invention, the operations for processing the service consumer request are described based on a Belief-Desire-Intention (BDI) software model. As shown in the figure, Agent Definition Module 106 incorporates software architectural elements associated with composition of an ADL file. An ADL file is created based on BDI model 108. The prime architectural components of BDI model 108 include Beliefs, Desires and Intentions. Beliefs symbolize informational state of a software agent in real-time including presumptive knowledge of an agent in addition to knowledge derived from the software environment. Beliefs are dynamic and change with addition to an agent's knowledge base. Desires represent primary set of objectives of an agent within which Goals signify desires actively pursued by an agent. Desires/Goals are achieved based on plans which are a sequence of actions performed by an agent. Plans are encapsulated as part of intentions, which represent a committed set of desires. A critical architectural component of BDI model 108 is Events which trigger reactive activity by an agent. Events may update beliefs, plans or modify goals. Based on changes in Goals, plans are updated which are then used to regularly update beliefs of the software agent.

The ADL file defines beliefs, goals and plans associated with the component 102. Beliefs associated with the component 102 represent configurable, monitorable and acceptable parameters of the component 102 that are associated with servicing a consumer request. In an exemplary embodiment of the present invention, component 102 may be a banking application implementing the processing of customer transaction requests received through the web. In an exemplary embodiment of the present invention, configurable, monitorable and acceptable parameters may include response times and encryption protocols used by the coarse grained component 102 for servicing the request based on type of request. Goals specified in the ADL file define operations to be carried out by the software agent 104 for configuration of the component 102 in order to process consumer requests. Plans defined in the ADL file include operations to be executed by the software agent 104 to achieve the specified goals. The operations to be executed include setting appropriate values to configurable parameters for processing consumer requests. In an embodiment of the present invention, parameter values are set based on a service contract created between the component 102 and a service consumer.

A service contract is created when a service request is received by the component 102. A parser within software agent 104 examines the request and decides the configurable and monitorable parameters of the component 102 associated with realization of service request requirements. The service contract is created in the form of rules to decide on configurable and monitorable parameters of the component 102 for servicing consumer requests. For example, if the component 102 is configured to service a banking transaction and the request type is detected to be a “High Value Transaction”, a corresponding rule for processing the request may be “Type of Encryption=XYZ”.

Once a service contract has been created, in an embodiment of the present invention, the modules: Component Properties Module 114, Monitor Properties Module 116 and Range Properties Module 118 are configured to interoperate dynamically with software agent 104 in order to describe, monitor and update parameters of the component 102. Component Properties Module 114 implements software functions or procedures describing the configurable parameters of the coarse grained component 102. Monitor Properties Module 116 contains all current parameters of the component 102 that are measurable. Monitor Component 120 continuously measures parameter values of the component 102 and updates parameter values in the module Monitor Properties Module 116. The parameter values are updated based on acceptable ranges of parameter values from the module Range Properties Module 118. In an exemplary embodiment, parameter ranges may include ranges of response times for servicing consumer requests.

In various embodiments of the present invention, the modules: Component Properties Module 114, Monitor Properties Module 116 and Range Properties Module 118 are provided as modular code objects. The code objects may be written in a platform independent language such as Java and are executed using Java Virtual Machine execution engine. In an embodiment of the present invention, the aforementioned modules may interact with each other using standardized function calls. In another embodiment of the present invention, the modules may communicate with each other by passing messages.

During interpretation of the ADL file, software agent 104 uses information such as, parameter values from Monitor Properties Module 116 and parameter description information from Component Properties Module 114 in order to determine whether current parameter values conform to requirements for processing of the consumer request. In an embodiment of the present invention, a BDI interpreter 112 within the software agent 104 reads information in the modules Component Properties Module 114 and Monitor Properties Module 116. In case, the parameters do not conform to requirements for servicing the consumer request, BDI interpreter 112 configures the component 102 by setting parameter values in the ADL file. After the setting of parameter values, plans in the ADL file are executed by the BDI interpreter 112 in order to process the service request.

In certain scenarios, component 102 may need to communicate with other software components within a software environment for processing a service consumer request. In various embodiments of the present invention, a blackboard application (not illustrated in the figure) is used for determining parameter values of all participating components involved in servicing the request. The blackboard application comprises a group of software components including component 102 implemented as a collection of software agents within the software environment. Each software component iteratively updates a shared software library with its current parameter values. For calculating parameter information about participating software components, each software component can access the shared software library dynamically. For example, in case the service request requirement for a request received by component 102 entails completion of the request within a certain period of time, the component 102 can access a shared software library for reading current values of response times of participating components. During interpretation of ADL file, in addition to reading current value of request response time of component 102 from Monitor Properties Module 116, BDI interpreter 112 reads response time values of participating components from the shared software library. BDI interpreter 112 then computes total response time for servicing the request and then compares the total response time value with a pre-specified time value for determining whether request requirements are conformed.

In various embodiments of the present invention, in addition to defining beliefs, goals and plans in the ADL file, additional operations such as entering into a contract with a new consumer or communicating with other software components are also defined. These operations are interpreted by BDI interpreter 112 for processing service requests from new consumer applications or for coordinating with other software components in order to process a service request.

In various embodiments of the present invention, the software agent 104 is composed using an Integrated Development Environment (IDE) 110 comprising a source code editor and build automation tools. IDE 110 may represent a Java-based development environment and the software agent 104 may be composed using Java Agent Development Framework (JADE). In another embodiment of the present invention, IDE 110 is a .NET framework.

It may be apparent to a person skilled in the art that the system of the present invention is not limited to the embodiments described herein. In various embodiments of the present invention, the system of the present invention may include a plurality of software agents embedded within a plurality of software components, including the software agent 104 embedded within the component 102. The plurality of software agents are configured to interact with each other for processing consumer requests and further adapted to automatically configure the plurality of software components according to changing consumer requirements.

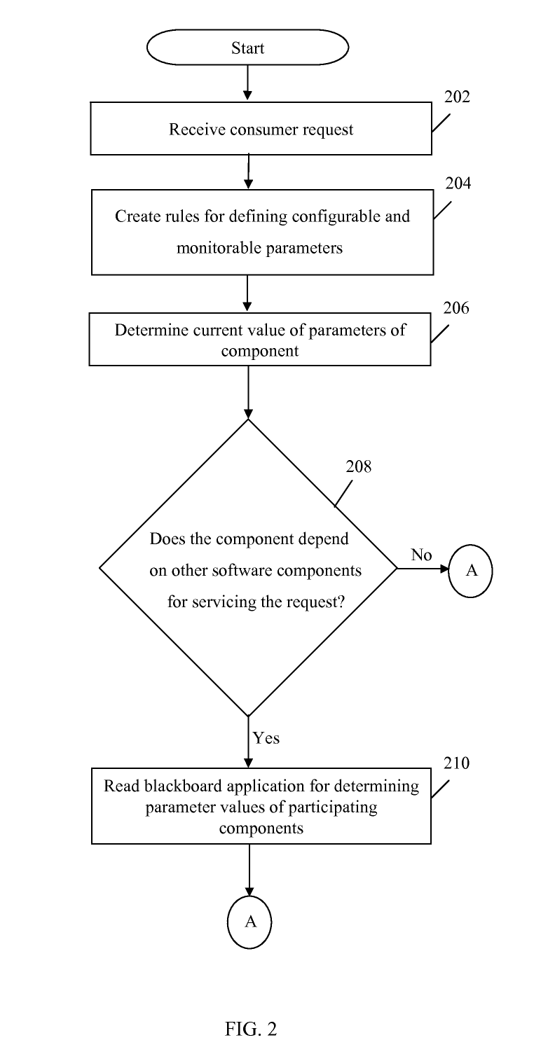

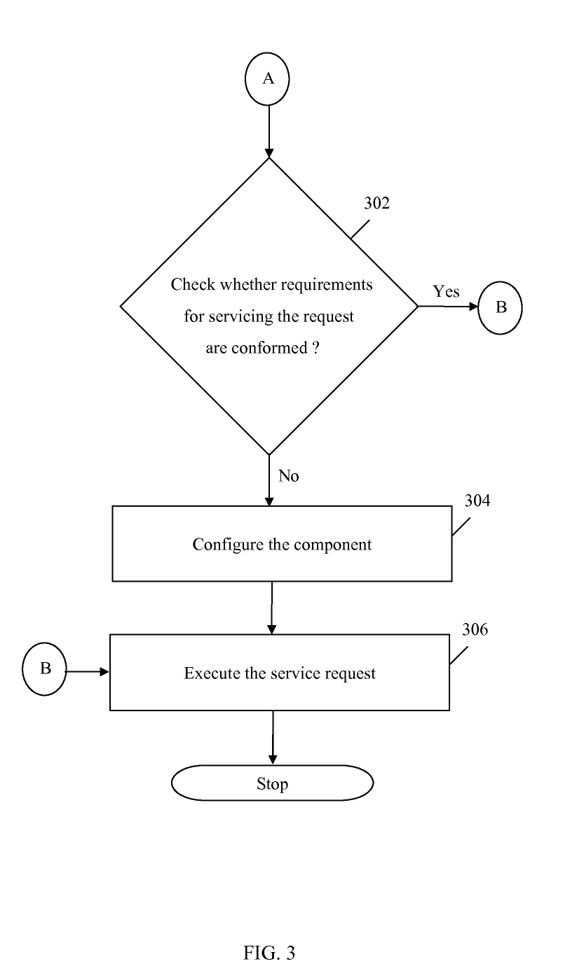

FIG. 2 is a flow diagram illustrating an exemplary implementation of method steps for automatic configuration of a software component in order to service a consumer request, in accordance with an embodiment of the present invention. At step 202, a consumer request is received by a software component. The software component is an agent-enabled component comprising software code for automatically configuring the component based on requirements of the service request. Upon receiving the consumer request, at step 204, one or more rules are created for defining configurable and monitorable parameters of the component. A software agent, which is part of the software component is configured to understand requirements of the request at run-time and re-configure the component at run-time (if necessary) in order to meet the requirements. For defining the configurable and monitorable parameters, firstly, one or more parameters which are significant for realization of service request are detected. Detection of the one or more significant parameters is based on various criteria such as type of request, source of request, security aspects related to servicing the request etc. For example, in case of a banking transaction request for a “High Value Transaction”, a significant parameter for realization of the request may be a highly secure encryption protocol to be used for executing the transaction. Therefore, a rule can be created by the software agent for defining type of encryption protocol that should be used for servicing the “High Value Transaction”. In another example, response time for servicing the request may be a significant parameter based upon category of customer requesting a banking transaction. In an exemplary embodiment of the present invention, a parser implemented by the software agent may create a rule defining parameter values based on “Type of customer”, such as: If (customer==“type”) then ResponseTime=“rsec” and Encryption=“XYZ”. In an embodiment of the present invention, one or more rules corresponding to a consumer request may be created in the form of a service contract. These rules are then used later by the software agent for configuring parameter values of the component in order to satisfy the requirements of the request.

Following the creation of one or more rules, it is determined by the software agent whether current parameter values of the component conform to the requirements of the service request. At step 206, parameters defined as per the rules are monitored for determining their current value. In an embodiment of the present invention, for obtaining current values of parameters, the software agent interprets an ADL file that comprises software code for reading parameter values from one or more files storing real-time values of component parameters. An ADL file basically comprises software code including operations describing Beliefs, Goals and Plans of a software agent, that relate in effect to configuration, monitoring and execution of service requests processed by the component. However, in various embodiments of the present invention, one or more elements of the service request may be required to be processed by other software components in addition to the primary software component receiving the request. This may be due to various reasons including, but not limited to, service quality requirements, availability of resources with each component, speed of service execution, etc. In case where the primary software component depends on other components for servicing a request, current value of a significant parameter may be a combination of individual parameter values of all components participating in servicing the request. For example, in case of a significant parameter i.e. response time for servicing the request, the current response time is a combination of individual response times of participating components involved in servicing the request. Thus, for the purpose of determining current value of a parameter, at step 208, it is first determined whether the primary software component receiving the consumer request depends on other software components for servicing the request.

In an embodiment of the present invention, if it is determined at step 208 that the primary component depends on other components for servicing the consumer request, the flow proceeds to step 210. At step 210, the software agent of the primary component reads a blackboard application for determining parameter values of components participating in servicing the request. The blackboard application is a centralized application implementing a shared software library which is regularly updated by one or more components that coordinate with each other for servicing consumer requests. In an embodiment of the present invention, the one or more components update the shared software library with parameter values corresponding to each type of consumer request serviced by them. For determining a consolidated value of parameter corresponding to a particular service request, the software agent of the primary software component reads parameter values posted by one or more components on the shared software library and calculates the consolidated value. For example, total response time for servicing a consumer request is calculated by software agent of the primary software component by adding individual response time values of each component participating in servicing the request. The calculated consolidated parameter value is then used at step 302 for determining whether requirements for servicing the request are conformed.

In another embodiment of the present invention, if it is determined at step 208 that the primary software component receiving the request is servicing the request entirely by itself, a current value of the significant parameter is determined by monitoring and the flow directly proceeds to step 302.

At step 302, for determining whether requirements for servicing the request are conformed, the software agent compares current values of significant parameters with parameter values defined as per the rules of the service contract. If it is determined that requirements for servicing the request are conformed, the software agent executes the service request at step 306. In an embodiment of the present invention, the software agent executes a script within an ADL file for executing the request. The ADL file is an executable file encapsulating plans for executing goals corresponding to the software component.

However, if it is determined at step 302 that the requirements for servicing the request are not conformed, the software agent configures the parameters of the component at step 304. For configuring the parameters of the component the software agent interprets the ADL file. An interpreter within the software agent acquires rule definitions corresponding to significant parameters from the service contract and sets parameter values according to the rule definitions. For example, if a rule in the client contract is: Encryption=“XYZ”, the software agent sets the encryption protocol as “XYZ”. Thereafter, the software agent processes the service request at step 306 by executing a script coded in the ADL file.

The method and system of the present invention implements a mechanism of designing coarse grained software components or Application Programming Interfaces (APIs) having self re-configuration capabilities. Further, it also provides a mechanism of injection of continuous configurability aspect into pre-existing software components and APIs. This enables incorporation of self-configurability aspects into components used within widely used component deployment systems such as Service Component Architecture (SCA) platform and Java Business Integration (JBI) platform. This eliminates the requirement of manual configuration of components for meeting the requirements of individual consumers.

The method and system for implementing self-configurable software components as described in the present invention or any of the embodiments, may be realized in the form of a computer system. Typical examples of a computer system include a general-purpose computer, a programmed microprocessor, a micro-controller, a peripheral integrated circuit element, and other devices or arrangement of devices that are capable of implementing the steps that constitute the method of the present invention. However, various embodiments of the present invention may be implemented via one or more computer systems. The computer system is not intended to suggest any limitation as to scope of use or functionality of described embodiments.

The computer system typically comprises a computer, a microprocessor, an input device, a display unit and among other units of a computer. The microprocessor is connected to a communication bus. The computer also includes a computer usable medium such as a memory containing computer readable program codes. The memory may include Random Access Memory (RAM) and Read Only Memory (ROM). The computer system further comprises a storage device. The storage device can be a hard disk drive or a removable storage drive such as a floppy disk drive, optical disk drive, etc. The storage device can also be other similar means for loading computer programs or computer readable program code or other instructions into the computer system. The computer system also includes a communication unit. The communication unit allows the computer to connect to other databases and computers on a network through an I/O interface. The communication unit allows the transfer as well as reception of data from other databases. The communication unit may include a modem, an Ethernet card, or any similar device which enables the computer system to connect to databases and networks such as LAN, MAN, WAN, and the Internet. The computer system facilitates inputs from a user through input device, accessible to the system through I/O interface.

The computer system executes a set of instructions that are stored in one or more storage elements to process input data. The storage elements may also hold data or other information, as desired, and may be an information source or physical memory element present in the processing machine. The set of instructions may include various commands that instruct the processing machine to perform specific tasks such as the steps that constitute the method of the present invention. The set of instructions may be in the form of a software program. Further, the software may be in the form of a collection of separate programs, a program module with a larger program or a portion of a program module, as in the present invention. The software may also include modular programming in the form of object-oriented programming. The processing of input data by the processing machine may be in response to user commands, results of previous processing or a request made by another processing machine.

The present invention may suitably be embodied as a computer program product for use with a computer system. The method described herein is typically implemented as a computer program product, comprising a set of program instructions for controlling a computer or similar device. The set of program instructions may be a series of computer readable instructions fixed on a tangible medium, such as a computer readable storage medium, for example, diskette, CD-ROM, ROM, or hard disk, or transmittable to a computer system, via a modem or other interface device, over either a tangible medium, including but not limited to optical or analogue communications lines. The implementation of the invention as a computer program product may be in an intangible form using wireless techniques, including but not limited to microwave, infrared or other transmission techniques These instructions can be supplied preloaded into a system or recorded on a storage medium such as a CD-ROM, or made available for downloading over a network such as the Internet or a mobile telephone network. The series of computer readable instructions may embody all or part of the functionality previously described herein. It is contemplated that the computer program product may be distributed as a removable medium with accompanying printed or electronic documentation, for example, shrink-wrapped software, pre-loaded with a computer system, for example, on a system ROM or fixed disk, or distributed from a server or electronic bulletin board over a network, for example, the Internet or World Wide Web.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

What is claimed is:

1. A computer-implemented method for implementing automatic self-configuration of a software component for servicing consumer requests, the method comprising:
receiving, using program instructions executed by a computer system, a consumer request for a software service by the software component, wherein the software component includes a software agent adapted to automatically configure the software component based on requirements of the consumer request;
creating, using program instructions executed by a computer system, one or more rules for defining one or more parameters of the software component based on requirements of the consumer request, wherein the one or more parameters are detected to be significant to realization of the consumer request, further wherein the one or more parameters are programmed to be monitorable and configurable by the software agent;
determining, using program instructions executed by a computer system, current values of the one or more parameters;
checking, using program instructions executed by a computer system, whether requirements for servicing the consumer request are conformed, wherein checking of requirements is performed by the software agent by comparing current values of the one or more parameters with values defined as per the created rules;
configuring, using program instructions executed by a computer system, at least one parameter of the one or more parameters, if it is determined that requirements for servicing the consumer request are not conformed, wherein configuration of the at least one parameter is performed by the software agent by setting values for the at least one parameter;
and
executing the consumer request using program instructions executed by a computer system.

2. The method of claim 1, wherein current values of the one or more parameters are determined by dynamically monitoring their values.

3. The method of claim 1, wherein the one or more parameters include parameters of participating software components, further wherein the participating software components are components involved in servicing the consumer request in addition to the software component.

4. The method of claim 3, wherein current values of the one or more parameters are obtained by combining individual parameter values of the participating software components with values of parameters of the software component, further wherein the individual parameter values are obtained from a shared software library implemented using a blackboard application.

5. The method of claim 1, wherein the software component is a coarse grained component.

6. The method of claim 1, wherein the software agent is composed using an Integrated Development Environment (IDE), wherein the IDE is a Java-based environment.

7. The method of claim 1, wherein the software agent is composed using an Integrated Development Environment (IDE), wherein the IDE is a .NET software framework.

8. The method of claim 1, wherein configuration and monitoring of the one or more parameters is performed during run time processing of the consumer request.

9. The method of claim 1, wherein the one or more parameters are detected based on various criteria such as type of consumer request, source of consumer request, security aspects of consumer request etc.

10. The method of claim 1, wherein executing the consumer request comprises interpreting, using program instructions executed by a computer system, an Agent Definition Language file, wherein the Agent Definition Language file comprises software code containing instructions for configuring parameter values of the software component and for processing the consumer request.

11. The method of claim 10, wherein the Agent Definition Language file further comprises software code containing instructions for deriving current values of the one or more parameters from a software file storing updated values of the one or more parameters.

12. The method of claim 11, wherein the current values of the one or more parameters are monitored and stored in the software file based on acceptable range of parameters.

13. A system for implementing automatic self-configuration of a software component for servicing consumer requests, the system comprising:
a software component comprising a software agent created to operate on behalf of the software component, wherein the software component in communication with a microprocessor is operative to: detect one or more parameters significant to realization of the consumer request, to create rules defining configurable and monitorable parameters of the component, to obtain current values of the configurable parameters, to configure values of the parameters based on requirements of the consumer request and to execute operations for processing the consumer request;
a component properties module in communication with the microprocessor and operative to implement software functions or procedures describing the one or more parameters;
a monitor component in communication with the microprocessor and operative to continuously measure values of the one or more parameters;
a monitor properties module in communication with the microprocessor and operative to receive and store updated values of the one or more parameters from the monitor component; and
a range properties module in communication with the microprocessor and operative to store acceptable ranges of values of the one or more parameters.

14. The system of claim 13, wherein the software agent comprises a parser in communication with the microprocessor and operative to examine the consumer request and determine the configurable and monitorable parameters of the software component.

15. The system of claim 13, wherein the software agent is adapted to compare rules defining the configurable and monitorable parameters with current values of the parameters based on requirements of the consumer request in order to determine whether the parameters are to be configured.

16. The system of claim 15, wherein configuration of parameters is realized by the software agent by setting values of parameters based on requirements of the consumer request.

17. The system of claim 13, wherein the software component is a coarse grained component.

18. The system of claim 13, wherein operations for processing the consumer request are described in an ADL file, further wherein the operations are described based on a BDI software model.

19. The system of claim 18, wherein the software agent comprises a BDI interpreter in communication with the microprocessor and operative to read current values of the configurable and monitorable parameters from the monitor properties module and further operative to interpret the ADL file for configuring values of the one or more parameters.

20. The system of claim 19, wherein the software agent is further operative to coordinate with components participating in servicing the consumer request in order to derive current values of parameters of the participating components.

21. The system of claim 13, wherein the software agent is composed using an Integrated Development Environment.

22. The system of claim 21, wherein the Integrated Development Environment is a Java-based development environment.

23. The system of claim 21, wherein the Integrated Development Environment is a .NET framework.

24. A computer program product comprising computer usable medium having computer-readable program code stored thereon, the computer-readable program code comprising instructions that, when executed by a microprocessor, cause the microprocessor to:
receive a consumer request for a software service by the software component, wherein the software component includes a software agent adapted to automatically configure the software component based on requirements of the consumer request;
create one or more rules for defining one or more parameters of the software component based on requirements of the consumer request, wherein the one or more parameters are detected to be significant to realization of the consumer request, further wherein the one or more parameters are programmed to be monitorable and configurable by the software agent;
determine current values of the one or more parameters;
check whether requirements for servicing the consumer request are conformed, wherein checking of requirements is performed by the software agent by comparing current values of the one or more parameters with values defined as per the created rules;
configure at least one parameter of the one or more parameters, if it is determined that requirements for servicing the consumer request are not conformed, wherein configuration of the at least one parameter is performed by the software agent by setting values for the at least one parameter;
and
execute the consumer request.

25. The computer program product of claim 24, wherein the computer-readable program code for executing the consumer request comprises instructions that, when executed by the microprocessor, cause the microprocessor to interpret an Agent Definition Language file, wherein the Agent Definition Language file comprises software code containing instructions for configuring parameter values of the software component and for processing the consumer request.
